(19) United States
(12) Patent Application Publication
(10) Pub. No.: US 2026/0280705 A1
(43) Pub. Date: Sep. 17, 2026

(54) SYSTEMS AND METHODS FOR TRANSMIT AND RECEIVE APERTURE ALIGNMENT IN OPTICAL GROUND STATIONS USING BEAM DIRECTION FEEDBACK

(71) Applicant: Astrolight UAB, Vilnius (LT)

(72) Inventor: Dalius PETRULIONIS, Druskininku sav. (LT)

(21) Appl. No.: 19/563,349

(22) Filed: Mar. 11, 2026

Related U.S. Application Data
(60) Provisional application No. 63/770,047, filed on Mar. 11, 2025.

(51) Int. Cl. H04B 10/112; G02B 26/08; H04B 10/50

(52) U.S. Cl. CPC H04B 10/1123; G02B 26/0816; H04B 10/1129; H04B 10/503

(57) ABSTRACT

A system for optical ground station transmitting and receiving aperture alignment includes a laser source configured to generate and transmit an optical beam; a beamsplitter configured to direct a first portion of the optical beam toward a mirror and a second portion of the optical beam toward a retroreflector; the mirror configured to deflect the first portion of the optical beam; an optical system configured to relay the first portion of the optical beam from the mirror to a transmit aperture; the retroreflector configured to reflect the second portion of the optical beam and to return the reflected optical beam to the beamsplitter; a lens positioned to convert an angular displacement of the optical beam into a lateral displacement spot; a camera positioned to detect the lateral displacement spot; and a controller configured to adjust an angular deflection of the mirror to align a transmit aperture and a receive aperture.

### CROSS-REFERENCE TO RELATED APPLICATION

This application claims the benefit of and priority to U.S. Provisional Patent Application No. 63/770,047 filed on Mar. 11, 2025, the entire contents of which is incorporated by reference herein.

### TECHNICAL FIELD

The subject matter of the present disclosure relates generally to optical ground stations (OGS) for free-space optical (FSO) communication, and in particular to systems and methods for aligning a transmitting aperture and a receiving aperture by angularly controlling a transmitted optical beam and measuring a corresponding displacement of the beam on a tracking camera via a retroreflector and lens arrangement.

### BACKGROUND

Current optical ground station (OGS) systems configured for free-space optical (FSO) communication commonly employ separate transmit and receive apertures. For such systems to operate effectively, the optical axes of the transmitting and receiving apertures must be substantially parallel in order to ensure accurate beacon pointing and reliable link acquisition. However, alignment between spatially separated apertures can degrade over time due to environmental and mechanical perturbations such as temperature variation, vibration, structural deformation, and mechanical loading. Conventional alignment techniques often rely on precision retro-reflecting prism assemblies that translate a beam laterally while maintaining strict parallelism with the incident beam. Although effective, such retroreflecting devices can be difficult to manufacture, costly, and mechanically complex, thereby increasing overall system expense and integration challenges.

Accordingly, there remains a need for systems and methods capable of aligning transmitting and receiving apertures in an optical ground station using a simplified and self-referenced architecture. In particular, there is a need for approaches that utilize a modified transmitting subsystem incorporating beam steering elements and imaging capability to observe distant objects, thereby permitting alignment of both apertures by directing them toward a common distant reference object. Such methods may reduce system complexity, facilitate on-the-fly recalibration, and improve long-term robustness in terrestrial and aerospace operating environments.

### SUMMARY

In accordance with aspects of the present disclosure, a system for optical ground station transmitting and receiving aperture alignment includes a laser source configured to generate and transmit an optical beam; a beamsplitter configured to receive the optical beam from the laser source and to direct a first portion of the optical beam toward a mirror and a second portion of the optical beam toward a retroreflector; the mirror configured to angularly deflect the first portion of the optical beam; an optical system configured to relay the first portion of the optical beam from the mirror to a transmit aperture; the retroreflector configured to reflect the second portion of the optical beam parallel to an incident beam and to return the reflected second portion of the optical beam to the beamsplitter; a lens positioned to receive the reflected optical beam from the beamsplitter and to convert an angular displacement of the optical beam into a lateral displacement spot; a camera positioned to detect the lateral displacement spot and determine a direction of an output optical beam; and a controller configured to adjust an angular deflection of the mirror based on feedback from the camera to align the transmit aperture and a receive aperture.

In an aspect of the present disclosure, the retroreflector may be configured to translate the optical beam laterally while maintaining the reflected optical beam parallel to the incident beam.

In an aspect of the present disclosure, the camera may be further configured to register an image of a distant object by receiving light incident to the transmit aperture.

In an aspect of the present disclosure, light from the distant object may propagate through the optical system, the mirror, and the beamsplitter to the lens and the camera.

In an aspect of the present disclosure, the mirror may be configured to deflect the optical beam within two orthogonal angular directions.

In an aspect of the present disclosure, the controller may be configured to tune the angular deflection of the mirror such that the output optical beam is directed toward the distant object visible to the camera.

In an aspect of the present disclosure, alignment between the transmit aperture and the receive aperture may be achieved by directing both the transmit aperture and the receive aperture toward the distant object.

In an aspect of the present disclosure, the distant object may include a celestial object located at a distance sufficient such that angular misalignment between the transmit aperture and the receive aperture is negligible.

In an aspect of the present disclosure, the beamsplitter may be configured to transmit a portion of optical power toward the mirror and a portion of optical power toward the retroreflector.

In an aspect of the present disclosure, the transmit aperture and the receive aperture may be spatially separated and may define respective optical axes that are aligned to be substantially parallel.

In accordance with aspects of the present disclosure, a method for aligning a transmit aperture and a receive aperture of an optical ground station includes transmitting an optical beam from a laser source to a beamsplitter; directing a first portion of the optical beam from the beamsplitter to a mirror; directing a second portion of the optical beam from the beamsplitter to a retroreflector; deflecting the first portion of the optical beam with the mirror and relaying the deflected optical beam through an optical system to a transmit aperture; reflecting the second portion of the optical beam with the retroreflector parallel to an incident beam and returning the reflected optical beam to the beamsplitter; converting an angular displacement of the reflected optical beam into a lateral displacement spot with a lens; detecting the lateral displacement spot with a camera to determine a direction of the output optical beam; and adjusting an angular deflection of the mirror based on feedback from the camera to align the transmit aperture and the receive aperture.

In an aspect of the present disclosure, the method may further include registering an image of a distant object by gathering light incident to the transmit aperture using the camera.

In an aspect of the present disclosure, the method may further include directing the output optical beam toward the distant object visible to the camera.

In an aspect of the present disclosure, the method may further include directing a receive aperture toward the distant object to align respective optical axes of the transmit aperture and the receive aperture.

In an aspect of the present disclosure, reflecting the second portion of the optical beam may include laterally translating the optical beam while maintaining parallelism with the incident beam.

In an aspect of the present disclosure, adjusting the angular deflection of the mirror may include tuning the mirror in two orthogonal angular directions.

In an aspect of the present disclosure, the method may further include recalibrating alignment between the transmit aperture and the receive aperture in response to environmental or mechanical perturbations.

In an aspect of the present disclosure, the distant object may be selected such that increasing distance to the distant object increases alignment precision.

In an aspect of the present disclosure, reducing lateral displacement between the transmit aperture and the receive aperture increases alignment precision.

In accordance with aspects of the present disclosure, a system for optical ground station transmitting and receiving aperture alignment includes a laser source configured to generate a beacon optical beam; a beamsplitter configured to divide the beacon optical beam into a transmit portion and a reference portion; a mirror configured to steer the transmit portion of the beacon optical beam; an optical relay system configured to direct the steered transmit portion through a transmit aperture; a retroreflector configured to reflect the reference portion parallel to an incident beam and return the reflected reference portion through the beamsplitter; a lens configured to convert angular displacement of the reflected reference portion into a lateral displacement at an image plane; a tracking camera positioned at the image plane and configured to detect both the lateral displacement and an image of a distant object; and a controller configured to determine a pointing direction of the beacon optical beam based on the lateral displacement, adjust the mirror to direct the beacon optical beam toward the distant object, and align an optical axis of the transmit aperture and an optical axis of the receive aperture by referencing the distant object.

Further details and aspects of exemplary embodiments of the present disclosure are described in more detail below with reference to the appended figures.

### BRIEF DESCRIPTION OF THE DRAWINGS

A better understanding of the features and advantages of the present disclosure will be obtained by reference to the following detailed description that sets forth illustrative embodiments, in which the principles of the present disclosure are utilized, and the accompanying drawings of which:

FIG. 1 is a diagram of a system for optical ground station transmitting and receiving aperture alignment, in accordance with aspects of the present disclosure;

FIG. 2 is a flowchart of a method for aligning a transmit aperture and a receive aperture of an optical ground station, in accordance with aspects of the present disclosure; and

FIG. 3 is a block diagram of a controller configured for use with the system of FIG. 1, in accordance with aspects of the present disclosure.

### DETAILED DESCRIPTION

The present disclosure relates generally to systems and methods for aligning transmitting and receiving apertures in optical ground stations used for free-space optical communication, and in particular to systems and methods for determining and controlling transmit-beam pointing direction using an internal beam-splitting and retroreflection architecture in combination with imaging and feedback control. The present disclosure provides precise determination of transmitted beam direction by converting angular displacement into a measurable lateral displacement at an image plane, supports alignment of spatially separated transmit and receive apertures by referencing a common distant object, and provides a compact and self-contained approach for maintaining substantially parallel optical axes under varying environmental and mechanical conditions. By using beam steering from a mirror together with optical feedback through a beamsplitter, retroreflector, lens, and tracking camera arrangement, the disclosed systems support in situ alignment, recalibration, and long-term stability of optical ground station terminals without requiring external alignment fixtures or retroreflecting translation assemblies that are difficult to manufacture and/or expensive.

Although the present disclosure will be described in terms of specific examples, it will be readily apparent to those skilled in this art that various modifications, rearrangements, and substitutions may be made without departing from the spirit of the present disclosure.

For the purpose of promoting an understanding of the principles of the present disclosure, reference will now be made to exemplary embodiments illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

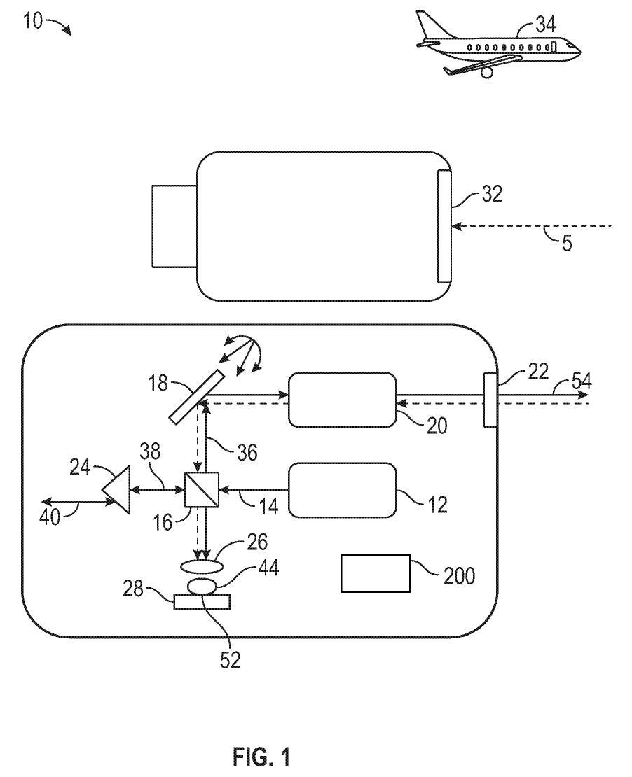

Referring to FIG. 1, a system 10 for optical ground station transmitting and receiving aperture alignment is shown in accordance with aspects of the present disclosure. The system 10 includes a laser source 12 configured to generate and transmit an optical beam 14, a beamsplitter 16 positioned to receive the optical beam 14 from the laser source 12, a mirror 18 positioned to receive a first portion 36 of the optical beam 14 from the beamsplitter 16, an optical system 20 (e.g., an optical relay system) positioned to relay the first portion 36 of the optical beam 14 from the mirror 18 to a transmit aperture 22, a retroreflector 24 positioned to receive a second portion 38 of the optical beam 14 from the beamsplitter 16, a lens 26 positioned to receive the reflected optical beam 14 returned from the retroreflector 24 through the beamsplitter 16 and to convert angular displacement of the reflected optical beam 14 into a lateral displacement spot 44 at an image plane 52, a camera 28 positioned at the image plane 52 to detect the lateral displacement spot 44 and determine a direction of an output optical beam 54, and a controller 200 configured to adjust an angular deflection of the mirror 18 based on feedback from the camera 28 to align the transmit aperture 22 and a receive aperture 32 configured to receive an optical signal 5 from a distant object 34.

In some embodiments, the optical beam 14 generated by the laser source 12 is a local beacon or alignment beam produced within the system 10 and transmitted through the transmit aperture 22 as the output optical beam 54. Separately, the receive aperture 32 is configured to receive an optical signal 5 originating from the distant object 34, such as a downlink communication signal, a beacon emitted by the distant object 34, or reflected/ambient light associated with the distant object 34.

During alignment, the system 10 uses the distant object 34 as a common reference for both transmit and receive pointing. In particular, the camera 28 registers an image of the distant object 34 associated with the received optical signal 5, while the controller 200 commands the mirror 18 to steer the output optical beam 54 to coincide with a direction of the distant object 34 in the image. In this manner, the system 10 aligns a transmit optical axis associated with the transmit aperture 22 with a receive optical axis associated with the receive aperture 32 by referencing the same distant object 34.

In various embodiments, the system 10 is integrated in a single optical head or terminal housing mounted on a gimbal, pedestal, or other pointing platform used by an optical ground station, with the transmit aperture 22 and the receive aperture 32 arranged as spatially separated apertures on the same structure. The transmit aperture 22 may be associated with a transmit telescope, beam expander, or exit window of the optical system 20, and the receive aperture 32 may be associated with a receive telescope or collection optic that has a receive optical axis intended to be substantially parallel to a transmit optical axis associated with the transmit aperture 22. Structural features such as a common baseplate, kinematic mounts, flexures, or thermally matched materials may be used to maintain relative stability between the transmit aperture 22 and the receive aperture 32 while still permitting serviceability and alignment adjustment during assembly.

In operation, the system 10 provides a self-referenced pointing observable through the lateral displacement spot 44 at the image plane 52, where motion of the lateral displacement spot 44 corresponds to changes in a pointing direction of the output optical beam 54. This self-referenced observable may be used during commissioning, periodic calibration, and on-the-fly correction to compensate for mechanical drift, thermal expansion, wind loading, vibration, and other perturbations that can change the relationship between the transmit aperture 22 and the receive aperture 32 over time. The system 10 also supports object-referenced alignment by imaging the distant object 34 on the camera 28, so that the controller 200 commands the mirror 18 while the output optical beam 54 is directed toward the distant object 34 visible to the camera 28. In this manner, the transmit aperture 22 and the receive aperture 32 may be directed toward the same distant object 34 for repeatable co-boresighting, including co-boresighting based on terrestrial landmarks, aircraft, satellites, or celestial objects selected to reduce sensitivity to parallax. In embodiments, the camera 28 performs both spot detection of the lateral displacement spot 44 and scene imaging of the distant object 34 by time-multiplexing acquisition modes, by spectral filtering, by region-of-interest processing at the image plane 52, or by a combination thereof, while the controller 200 maintains closed-loop control of the mirror 18.

The laser source 12 provides the optical beam 14 used as a measurement beam for alignment and calibration. In various embodiments, the laser source 12 includes a diode laser, a distributed feedback laser, a vertical-cavity surface-emitting laser, a fiber laser, a diode-seeded fiber laser, or a diode-pumped solid-state laser selected based on wavelength, linewidth, output power, beam quality, modulation bandwidth, and environmental robustness. In some embodiments, the laser source 12 is selected to provide a single spatial mode output for stable pointing characterization and repeatable propagation through the beamsplitter 16 and the optical system 20, while in other embodiments the laser source 12 provides a controlled multimode output selected for improved power margin or relaxed optical tolerances. In certain implementations, the laser source 12 is a dedicated alignment source. In other implementations, the laser source 12 is shared with a communication transmitter so that the optical beam 14 used for calibration propagates along the same path as an operational transmit beam associated with the transmit aperture 22, thereby directly referencing the deployed optical train.

Suitable wavelengths include near-infrared wavelengths used for free-space optical communication and eye-safe operation, such as approximately 1310 nanometers and approximately 1550 nanometers, as well as other wavelengths selected based on atmospheric transmission windows, detector responsivity of the camera 28, and coating performance within the optical system 20. In some embodiments, the laser source 12 operates at approximately 1064 nanometers, approximately 980 nanometers, or approximately 808 nanometers for compatibility with particular optical materials or detectors. In other embodiments, the laser source 12 operates at visible or near-visible wavelengths for alignment diagnostics when visual confirmation is desirable, such as approximately 532 nanometers, approximately 635 nanometers, or approximately 850 nanometers. In some embodiments, the laser source 12 generates the optical beam 14 at a first wavelength used for formation of the lateral displacement spot 44 at the image plane 52, while a separate communication beam at a second wavelength is transmitted through the transmit aperture 22. Spectral separation may be provided by wavelength-selective coatings, dichroic elements, or filters positioned within the optical system 20 and at the camera 28. In other embodiments, the optical beam 14 is selected to be close in wavelength to an operational communications wavelength so that chromatic pointing offsets through the optical system 20 are reduced.

The laser source 12 may operate in continuous-wave mode for steady formation of the lateral displacement spot 44 at the image plane 52, or the laser source 12 may operate in a modulated mode. Modulation may include amplitude modulation, pulse modulation, burst modulation, or coded modulation so that the camera 28 and the controller 200 can distinguish the lateral displacement spot 44 from background illumination and stray reflections. In some embodiments, modulation supports synchronous detection by the controller 200, including processing coordinated with exposure timing of the camera 28, thereby improving signal-to-noise ratio under daylight operation or high-background conditions. In certain embodiments, the optical beam 14 includes a pilot tone or tag modulation so that the lateral displacement spot 44 is detected within a defined temporal band. In other embodiments, the optical beam 14 is time-multiplexed with scene imaging of the distant object 34 so that the camera 28 alternates between measuring the lateral displacement spot 44 and registering an image of the distant object 34 at the image plane 52. In some embodiments, the optical beam 14 is transmitted at a reduced duty cycle during acquisition to limit average power while retaining sufficient peak intensity for reliable centroid detection, and in other embodiments the optical beam 14 is transmitted continuously during closed-loop tracking.

In embodiments intended for fielded optical ground stations, the laser source 12 is packaged with thermal control hardware such as a thermoelectric cooler, a thermistor, and closed-loop drive electronics to maintain wavelength and output stability across diurnal temperature swings, wind-driven convection, enclosure heating, and solar loading. The laser source 12 may be mounted to a thermally conductive baseplate coupled to a chassis, cold plate, or forced-air heat exchanger. In other embodiments, the laser source 12 is mounted in a sealed module with environmental barriers to reduce humidity exposure and contamination. For systems deployed in high-vibration environments, the laser source 12 may be secured using vibration-resistant fasteners, compliant mounts, or low-outgassing potting materials selected for stable mechanical properties over temperature.

Optical characteristics of the laser source 12 may be selected to support stable pointing interpretation at the camera 28. In some embodiments, linewidth and coherence properties of the laser source 12 are selected so that speckle and interference artifacts at the camera 28 are reduced, including through broadened linewidth operation or intentional phase modulation. In other embodiments, the optical beam 14 is polarized with a defined polarization state, and the laser source 12 includes polarization-maintaining output coupling so that polarization-dependent behavior within the beamsplitter 16 and the optical system 20 remains stable. In certain embodiments, the laser source 12 includes an optical isolator to reduce sensitivity to back reflections propagating toward the laser source 12 through the beamsplitter 16. In further embodiments, the laser source 12 includes a monitor photodiode used to measure emitted power for calibration logging and power normalization by the controller 200.

Output power of the laser source 12 may vary based on system class and measurement geometry. In some embodiments, the laser source 12 outputs optical power in the milliwatt range for compact terminals, short-range alignment procedures, or systems with separate wavelength for alignment and transmission. In other embodiments, the laser source 12 outputs optical power from tens of milliwatts up to tens of watts to support long-distance beacon transmission, higher ambient lighting conditions and additional optical losses through the beamsplitter 16 and the optical system 20. In further embodiments, the laser source 12 is configured for higher output powers in support of long-distance acquisition or reduced integration times at the camera 28, with operation maintained within applicable eye-safety constraints and managed by the controller 200. In certain embodiments, the controller 200 adjusts drive current of the laser source 12 based on measured intensity of the lateral displacement spot 44 so that the lateral displacement spot 44 remains within a target dynamic range at the camera 28 and avoids saturation or nonlinear centroid shifts.

In some embodiments, redundancy is provided at the laser source 12, including dual emitters coupled into a shared optical path or a secondary laser module mounted within the same enclosure to support continued alignment calibration after a single-point failure. In embodiments intended for long-duration deployment, the controller 200 logs operating hours, drive current, temperature history, and optical output stability of the laser source 12. The controller 200 may use these data to schedule recalibration sequences, adjust modulation parameters, or provide maintenance indications when aging or drift behavior is detected.

The beamsplitter 16 receives the optical beam 14 from the laser source 12 and separates the optical beam 14 into the first portion 36 directed toward the mirror 18 and the second portion 38 directed toward the retroreflector 24. In this manner, the beamsplitter 16 establishes a transmitted-beam path associated with the transmit aperture 22 and a reference path associated with the retroreflector 24 that supports formation of the lateral displacement spot 44 at the image plane 52. The beamsplitter 16 may be positioned in a collimated region of the optical beam 14, or the beamsplitter 16 may be positioned in a slightly converging or diverging region to accommodate packaging constraints and to control beam diameter on downstream components. In some embodiments, the beamsplitter 16 is mounted in a kinematic seat or flexure mount to maintain angular stability under vibration and temperature change while limiting stress-induced birefringence and wavefront error.

In various embodiments, the beamsplitter 16 includes a plate beamsplitter 16, a cube beamsplitter 16, a wedge beamsplitter 16, or a polarizing beamsplitter 16 used with an associated waveplate, with selection driven by polarization handling, packaging volume, wavefront quality, stray light suppression, and power management. A plate beamsplitter 16 may be selected for reduced cost and low mass, while a cube beamsplitter 16 may be selected for mechanical robustness and improved pointing stability due to reduced beam walk with angular tolerances. A wedge beamsplitter 16 may be selected to reduce ghost reflections and parasitic etalon effects by angularly separating secondary reflections. A polarizing beamsplitter 16 may be selected when polarization control is used to manage power distribution, reduce loss, or mitigate polarization-dependent response at the camera 28. In such embodiments, a half-wave plate or other polarization control element may be positioned upstream of the polarizing beamsplitter 16 to set a polarization state that yields a desired distribution between the first portion 36 and the second portion 38.

The beamsplitter 16 may be implemented with a selected split ratio so that a portion of optical power is transmitted or reflected toward the mirror 18 and a portion of optical power is transmitted or reflected toward the retroreflector 24. For example, the beamsplitter 16 may allocate at least 95% of optical power to the first portion 36 and at most 5% of optical power to the second portion 38, with other ratios used to balance transmitted beam power delivered through the transmit aperture 22 against sensing signal-to-noise ratio at the camera 28. In some embodiments, the split ratio is selected so that the first portion 36 supports an output optical beam 54 associated with acquisition or alignment procedures, while the second portion 38 provides sufficient return signal strength through the retroreflector 24 to form a stable lateral displacement spot 44 without saturating the camera 28. In other embodiments, the split ratio is closer to about 50:50 when the system 10 prioritizes reference measurement robustness over transmitted power margin. In further embodiments, the split ratio is selected so that the second portion 38 remains small enough to reduce susceptibility to stray reflections while remaining large enough to preserve centroid accuracy of the lateral displacement spot 44 at the image plane 52.

In some embodiments, the beamsplitter 16 is configured so that the first portion 36 is transmitted through the beamsplitter 16 and the second portion 38 is reflected toward the retroreflector 24, while in other embodiments the first portion 36 is reflected toward the mirror 18 and the second portion 38 is transmitted toward the retroreflector 24. The selected geometry may be based on mechanical layout and the preferred angle of incidence for coatings to maintain stable splitting performance. In certain embodiments, the beamsplitter 16 is oriented to minimize polarization-dependent loss and to limit sensitivity of the split ratio to small changes in incidence angle that may occur due to mechanical perturbations. In some embodiments, the beamsplitter 16 is positioned so that any residual reflections from the beamsplitter 16 propagate away from the camera 28, or are intercepted by a beam dump or baffle within the system 10.

In embodiments, coatings on the beamsplitter 16 are selected for the operational wavelength band and angle of incidence. The beamsplitter 16 may include a partially reflective dielectric coating designed to maintain a stable split ratio over temperature and humidity exposure. In other embodiments, the beamsplitter 16 includes a metallic coating selected for broadband operation, with an overcoat selected for durability and reduced oxidation. In some embodiments, the beamsplitter 16 includes anti-reflection coatings on one or both outer surfaces to reduce ghost reflections and to increase throughput for the first portion 36 delivered toward the mirror 18 and for the second portion 38 delivered toward the retroreflector 24. Where the camera 28 also registers an image of the distant object 34, coatings may be selected so that the beamsplitter 16 passes at least a portion of the spectral band of the distant object 34 while maintaining the desired splitting behavior for the optical beam 14.

The beamsplitter 16 substrate may include fused silica, BK7, or another optical material selected for low absorption, dimensional stability, and low wavefront distortion. Fused silica may be selected for low thermal expansion and improved wavefront stability in outdoor environments. BK7 or related crown glasses may be selected for ease of fabrication and availability. In some embodiments, the beamsplitter 16 is manufactured with optical flatness sufficient to limit introduced wavefront error in the first portion 36 and the second portion 38, with surface quality selected to reduce scatter that could contaminate the lateral displacement spot 44 at the image plane 52. In further embodiments, the beamsplitter 16 thickness and wedge angle are selected to reduce etalon fringes and to separate ghost images from the primary beam footprint at the camera 28.

In some embodiments, the beamsplitter 16 is integrated into a monolithic optical subassembly with the lens 26 and the camera 28 so that relative alignment between the beamsplitter 16, the lens 26, and the image plane 52 remains stable. In other embodiments, the beamsplitter 16 is mounted as a discrete element with adjustment features that permit initial alignment of the optical paths during assembly, after which the beamsplitter 16 is locked in place using clamps, adhesives, or mechanical staking suitable for the expected environmental conditions.

The mirror 18 (e.g., a tip-tilt mirror 18) angularly deflects the first portion 36 of the optical beam 14 to steer the optical beam 14 exiting the transmit aperture 22. The mirror 18 provides controlled beam pointing adjustments that compensate for mechanical tolerance stack-up, thermal drift, structural flexure, wind loading, and mount disturbances that occur in deployed optical ground stations. The mirror 18 may be positioned in a collimated section of the first portion 36 to provide a near-linear relationship between commanded mirror angle and far-field pointing angle at the transmit aperture 22. In other embodiments, the mirror 18 is positioned in a converging or diverging section of the first portion 36 to satisfy packaging constraints, with optical design selected so that the optical system 20 relays the angular deflection to the transmit aperture 22 with controlled magnification.

In various embodiments, the mirror 18 is a two-axis steering mirror configured to deflect the first portion 36 of the optical beam 14 within two orthogonal angular directions, including an azimuth direction and an elevation direction. The two orthogonal angular directions may correspond to a gimbal-like tip axis and tilt axis, or to independent actuators that control orthogonal rotational modes of a flexure-mounted mirror plate. In some embodiments, the mirror 18 provides a small-angle correction range used for fine co-boresighting between the transmit aperture 22 and the receive aperture 32. In other embodiments, the mirror 18 provides both fine steering for alignment and limited scanning for acquisition or calibration routines. The mirror 18 may provide angular deflection ranges that support microradian-level pointing trim and also support larger milliradian-level offsets for initial acquisition, with the optical system 20 and transmit aperture 22 selected so that the resulting far-field divergence and pointing authority meet link requirements.

The mirror 18 may include a fast-steering mirror mechanism driven by piezoelectric actuators, voice-coil actuators, galvanometer actuators, or microelectromechanical actuators. Piezoelectric-actuated mirror implementations may be selected for high stiffness and high bandwidth correction of jitter. Voice-coil implementations may be selected for larger stroke and smooth analog control. Galvanometer implementations may be selected when the mirror 18 also performs scan patterns or when angular range is prioritized. Microelectromechanical implementations may be selected for reduced size, reduced mass, and reduced power consumption in compact terminals or where multiple steering channels are used. In some embodiments, the mirror 18 includes a flexure hinge suspension that avoids mechanical backlash and provides repeatable angular motion. In other embodiments, the mirror 18 includes a gimbal structure, a torsional suspension, or a membrane suspension selected to provide desired resonant characteristics and cross-axis decoupling.

In embodiments, the mirror 18 includes position sensors such as capacitive sensors, optical sensors, or strain sensors for closed-loop mirror positioning. Capacitive sensing may be used for high-resolution position feedback with low latency. Optical sensing may be used where electrical noise immunity is prioritized or where temperature drift compensation is integrated. Strain-based sensing may be used where compact packaging is prioritized. In some embodiments, the mirror 18 uses closed-loop control to correct hysteresis, creep, and nonlinearity in actuators, and to maintain repeatable pointing when the controller 200 commands a sequence of deflection values. In other embodiments, the mirror 18 operates in open-loop mode using calibration data stored by the controller 200, with periodic recalibration to account for aging and thermal effects.

Mirror substrates for the mirror 18 may include fused silica, Zerodur®, silicon carbide, beryllium, aluminum, or another low-expansion or high-stiffness material selected for the operating environment and bandwidth requirements. Fused silica and Zerodur® may be selected for low thermal expansion and stable surface figure across diurnal outdoor temperature swings. Silicon carbide and beryllium may be selected for high stiffness-to-weight ratio and good thermal conductivity, including for fast settling and reduced thermal gradients. In some embodiments, the mirror 18 includes a lightweighted substrate or a ribbed backside structure that increases resonance frequency and reduces power required for high-rate corrections.

Reflective coatings on the mirror 18 may include protected silver, enhanced aluminum, gold, or dielectric multilayers selected to provide high reflectance at the wavelength of the optical beam 14 and to maintain durability under outdoor exposure. Protected silver may be selected for high reflectance in the visible and near-infrared with an overcoat that provides corrosion resistance. Enhanced aluminum may be selected for ruggedness and broad spectral performance. Dielectric multilayers may be selected where very high reflectance at the wavelength of the optical beam 14 is desired along with improved resistance to oxidation and abrasion. In some embodiments, the coating stack is selected to reduce polarization-dependent phase shifts that could otherwise influence downstream alignment sensing through the lens 26 and the camera 28.

In embodiments, the mirror 18 is mounted in a housing (not shown) with vibration isolation features to reduce wind-induced jitter and platform vibration coupling common in optical ground stations. The housing may include elastomeric isolators, wire-rope isolators, or tuned mass damping features selected to attenuate specific disturbance bands associated with the mount, gimbal, or enclosure. In some embodiments, the mirror 18 assembly is installed on a thermally stable baseplate fabricated from Invar, aluminum, titanium, or carbon-fiber-reinforced composite, with mounting features that limit stress transfer from the enclosure. In other embodiments, the mirror 18 includes environmental protection features such as a sealed cavity, purge ports, desiccant, or hydrophobic coatings to limit contamination on the reflective surface and to preserve pointing stability over long field deployments.

The optical system 20 relays the first portion 36 of the optical beam 14 from the mirror 18 to the transmit aperture 22. The optical system 20 defines the transmitted beam geometry at the transmit aperture 22, including beam diameter, divergence, wavefront quality, and boresight relationship between the mirror 18 and the transmit aperture 22. In operation, the optical system 20 maps the angular deflection introduced by the mirror 18 into a corresponding pointing direction of the optical beam 14 at the transmit aperture 22 while maintaining a controlled beam profile suitable for free-space propagation. The optical system 20 may also set the effective focal length and optical leverage between a commanded deflection of the mirror 18 and the resulting far-field pointing angle, which may be selected to balance pointing resolution, scan authority, and jitter sensitivity.

In various embodiments, the optical system 20 includes a telescope relay, an afocal beam expander, a Keplerian relay, a Galilean relay, or a reflective relay that conditions beam diameter, divergence, and wavefront at the transmit aperture 22. A telescope relay may be selected when the transmit aperture 22 is the clear aperture of a telescope assembly shared with other optical functions. An afocal beam expander may be selected when the optical beam 14 is launched as a near-collimated beam and a controlled divergence is desired for link budget and acquisition robustness. A Keplerian relay may be selected when internal foci are acceptable and when field stops or spatial filters are used to clean the mode. A Galilean relay may be selected when a compact layout without an internal focus is preferred. A reflective relay may be selected for broadband operation, reduced chromatic sensitivity, or improved thermal stability, and may take the form of an off-axis reflective telescope, a Cassegrain-type configuration, or a two-mirror afocal relay depending on packaging and aperture requirements.

The optical system 20 may include refractive elements fabricated from fused silica, BK7, or low-dispersion glasses, and/or reflective elements fabricated from aluminum, Zerodur®, silicon carbide, or beryllium for stiffness-to-weight benefits. Fused silica may be selected for low absorption and thermal stability in near-infrared bands commonly used for ground station links. BK7 may be selected for cost-effective visible and near-infrared performance in protected enclosures. Low-dispersion glasses may be selected where the optical system 20 supports multiple wavelengths, such as when the optical beam 14 is a beacon beam while a separate communication channel shares a portion of the optical system 20. For reflective embodiments, Zerodur® and silicon carbide may be selected to reduce thermally induced wavefront distortion and boresight drift. Aluminum may be selected for manufacturability and ease of lightweighting, optionally with athermal design features to control focus and alignment over temperature.

In some embodiments, optical surfaces of the optical system 20 are specified to maintain wavefront error targets consistent with coupling to a remote receiver, including surface figure specifications such as λ/10 or better at the wavelength of the optical beam 14 for precision links. Anti-reflection coatings on refractive surfaces and high-reflectivity coatings on reflective surfaces may be selected to reduce insertion loss and to reduce internal parasitic reflections that could degrade sensing using the lens 26 and the camera 28. In certain embodiments, the optical system 20 includes a protective window or dome at the transmit aperture 22, with coatings selected for abrasion resistance, moisture resistance, and reduced scatter in dusty or coastal environments.

In embodiments, the optical system 20 includes baffles and stray-light control features to reduce ghost reflections and to improve measurement fidelity at the camera 28. Stray-light control features may include internal knife-edge baffles, matte-black absorbing coatings, light traps, field stops, and beam dumps positioned to intercept unwanted reflections from lens surfaces, structural walls, and aperture edges. These features may reduce spurious illumination that could otherwise overlap with the lateral displacement spot 44 at the image plane 52 or reduce contrast in the image of the distant object 34 received by the camera 28. In some embodiments, the optical system 20 includes an internal pupil stop that stabilizes the exit pupil location and reduces sensitivity of the transmitted beam to small mechanical shifts.

The transmit aperture 22 may be implemented as an exit pupil defined by an aperture stop, a telescope output opening, or a protective window opening. In some embodiments, the transmit aperture 22 is the clear aperture of a telescope used to launch the optical beam 14 as the output optical beam 54. In other embodiments, the transmit aperture 22 is a defined mechanical opening at an enclosure wall, optionally co-located with an optical window that provides environmental sealing. The transmit aperture 22 may range from small apertures used for short-range links, such as apertures on the order of millimeters to a few centimeters, to larger apertures used for long-range links where reduced divergence improves link margin, such as apertures on the order of several centimeters to tens of centimeters. Larger transmit apertures 22 may be paired with beam expansion within the optical system 20 to reduce divergence and increase received power at a distant terminal, while smaller transmit apertures 22 may be paired with higher divergence to relax pointing requirements and improve acquisition probability.

In some embodiments, the optical system 20 is mechanically referenced to a common structural datum shared with a receive aperture 32 so that the optical axis of the transmit aperture 22 and the optical axis of the receive aperture 32 are maintained substantially parallel over temperature and mechanical loading. In other embodiments, the optical system 20 includes adjustable mounts, flexure-based alignment features, or kinematic interfaces that support factory boresighting followed by field verification using the camera 28 and the lateral displacement spot 44 at the image plane 52.

The retroreflector 24 receives the second portion 38 of the optical beam 14 from the beamsplitter 16, reflects the second portion 38 of the optical beam 14 to form a reflected optical beam 14 that is parallel to an incident beam 40, and returns the reflected optical beam 14 to the beamsplitter 16. The incident beam 40 corresponds to the beam incident on the retroreflector 24 along the reference path defined by the beamsplitter 16. The retroreflector 24 returns the reflected optical beam 14 with controlled angular behavior such that angular deviations introduced upstream manifest as predictable angular changes in the reflected optical beam 14 that are subsequently converted into lateral displacement of the lateral displacement spot 44 at the image plane 52 by the lens 26. In this manner, the retroreflector 24 establishes a geometrically stable reference path that converts upstream pointing variation into a measurable observable at the camera 28.

In various embodiments, the retroreflector 24 includes a corner-cube retroreflector 24 assembly formed as a trihedral prism having three mutually orthogonal reflective surfaces. The corner-cube retroreflector 24 assembly may be fabricated as a solid prism made from fused silica, BK7, or another optical glass, with internal reflection provided by total internal reflection or by metallic or dielectric coatings applied to the reflective faces. In other embodiments, the corner-cube retroreflector 24 assembly is formed as a hollow corner-cube structure composed of three precisely aligned planar mirrors mounted in a rigid frame. A hollow corner-cube retroreflector 24 assembly may reduce mass and may be selected for broadband performance or for reduced chromatic dispersion relative to a solid prism.

In other embodiments, the retroreflector 24 includes a cat’s-eye retroreflector 24 assembly that incorporates a focusing lens and a reflective surface positioned near a focal plane of the focusing lens. The cat’s-eye retroreflector 24 assembly may include a spherical lens with a mirrored rear surface, or a lens and a separate planar mirror positioned at a focal distance. A cat’s-eye retroreflector 24 assembly may be selected when reduced sensitivity to lateral displacement is desired or when packaging constraints favor an axial configuration. In further embodiments, the retroreflector 24 includes a roof prism, a Porro prism, an Amici prism, or another prism-based retroreflecting geometry selected to return the reflected optical beam 14 parallel to the incident beam 40 with defined inversion characteristics.

The retroreflector 24 may be fabricated from optical materials such as fused silica, BK7, low-expansion glass, or crystalline materials selected for thermal stability and low birefringence. For operation across wide temperature ranges, fused silica or low-expansion glass may be selected to reduce thermally induced angular drift. For lightweight or ruggedized implementations, the retroreflector 24 may include reflective surfaces fabricated from aluminum, Zerodur®, silicon carbide, or another structurally stable material with reflective coatings applied. Reflective coatings may include protected silver, enhanced aluminum, gold, or dielectric multilayer coatings selected to provide high reflectance at the wavelength of the optical beam 14 and to maintain durability under environmental exposure.

In embodiments consistent with lateral translation while maintaining parallelism, the retroreflector 24 is configured to translate the optical beam 14 laterally while maintaining the reflected optical beam 14 parallel to the incident beam 40. A corner-cube retroreflector 24 assembly inherently produces lateral displacement between the incident beam 40 and the reflected optical beam 14 when the incident beam 40 is offset from the apex of the corner-cube retroreflector 24 assembly. This lateral displacement may be selected to create spatial separation between the forward propagation path of the second portion 38 and the return path of the reflected optical beam 14. Such separation may be used to reduce overlap and parasitic interference at the beamsplitter 16, to reduce ghost reflections, and to provide clean routing toward the lens 26 and the camera 28.

In some embodiments, the magnitude of lateral translation produced by the retroreflector 24 is selected based on the beam diameter of the second portion 38 and the desired separation between forward and return paths. The retroreflector 24 may be positioned so that the reflected optical beam 14 clears structural elements, baffles, and mounts within the system 10 while remaining fully captured by the lens 26. In certain embodiments, the retroreflector 24 is mounted on a precision bracket or baseplate that fixes its angular orientation relative to the beamsplitter 16 and the lens 26, with alignment tolerances selected to maintain stable mapping between upstream angular deflection and downstream lateral displacement of the lateral displacement spot 44.

The retroreflector 24 may be provided in various physical shapes and mounting configurations. In some embodiments, the retroreflector 24 is a solid triangular prism mounted with its entrance face normal to the second portion 38 of the optical beam 14. In other embodiments, the retroreflector 24 is cylindrical in external form with an internal corner-cube geometry. In further embodiments, the retroreflector 24 is integrated into a monolithic optical block that also carries the beamsplitter 16 or the lens 26, reducing part count and improving relative alignment stability. The retroreflector 24 may be sealed within a protective housing to prevent contamination of reflective surfaces, particularly in outdoor optical ground station environments subject to dust, humidity, and temperature cycling.

In certain embodiments, the retroreflector 24 includes optical coatings or surface treatments selected to reduce polarization-dependent phase shifts or to manage spectral response when the output optical beam 54 is a beacon optical beam at a first wavelength and other wavelengths propagate through the same region. In other embodiments, the retroreflector 24 is selected to operate over a broad wavelength range so that the system 10 can use different alignment wavelengths without replacing the retroreflector 24.

Through its geometry and mounting, the retroreflector 24 provides a stable angular reference within the system 10. By returning the reflected optical beam 14 parallel to the incident beam 40, the retroreflector 24 ensures that changes in pointing introduced by the mirror 18 are preserved in the angular state of the reflected optical beam 14. The lens 26 then converts that angular state into the lateral displacement spot 44 at the image plane 52, allowing the camera 28 and the controller 200 to infer the pointing direction of the optical beam 14 transmitted through the transmit aperture 22.

The lens 26 is positioned to receive the reflected optical beam 14 from the beamsplitter 16 and converts angular displacement of the reflected optical beam 14 into the lateral displacement spot 44 at the image plane 52. In operation, the lens 26 performs an angle-to-position mapping such that a change in propagation angle of the reflected optical beam 14 corresponds to a change in position of the lateral displacement spot 44 at the image plane 52. The camera 28 measures the position of the lateral displacement spot 44 at the image plane 52, and the controller 200 uses that measured position as a pointing observable to adjust angular deflection of the mirror 18. The image plane 52 may be positioned at or near a focal plane of the lens 26 so that the angular state of the reflected optical beam 14 is converted into a lateral position with stable sensitivity and low ambiguity.

In various embodiments, the lens 26 includes a singlet lens 26, an achromatic doublet, an aspheric lens 26, or a multi-element imaging lens 26 assembly selected based on field of view, distortion, chromatic behavior, and a desired spot size of the lateral displacement spot 44 at the camera 28. A singlet lens 26 may be selected for compactness and low part count when the reflected optical beam 14 is substantially monochromatic and the required field of view is modest. An achromatic doublet may be selected when improved control of longitudinal chromatic aberration and lateral color is desired, including implementations where the camera 28 also registers an image of the distant object 34 while simultaneously observing the lateral displacement spot 44. An aspheric lens 26 may be selected to reduce spherical aberration and to produce a smaller, higher-contrast lateral displacement spot 44 across a wider angular range. A multi-element imaging lens 26 assembly may be selected when the camera 28 is used for combined beacon tracking, alignment measurement, and distant-object imaging, and when low distortion and high resolution are desired across a wide field of view.

The lens 26 may be fabricated from fused silica, BK7, or another optical material appropriate for the wavelength band of the reflected optical beam 14. In implementations using approximately 1310 nanometers or approximately 1550 nanometers, fused silica or infrared-grade glasses may be selected for low absorption and stable refractive index behavior over temperature. In implementations using visible alignment wavelengths, BK7 or other crown glasses may be selected for cost-effective manufacture and high optical quality. For broader wavelength coverage or harsher environments, the lens 26 may be fabricated from materials such as calcium fluoride or other low-dispersion materials selected to reduce chromatic variation and thermal sensitivity. In certain embodiments, the lens 26 is mounted in a low-expansion housing or in an athermalized mount that maintains focus position at the image plane 52 under diurnal temperature swings, enclosure heating, and wind-driven convection common in optical ground station deployments.

In various embodiments, the lens 26 includes anti-reflection coatings selected for the operational wavelength band and angle-of-incidence distribution. Broadband anti-reflection coatings may be selected to support both the reflected optical beam 14 and light from the distant object 34 that propagates through the optical system 20, the mirror 18, and the beamsplitter 16 to the lens 26 and the camera 28. Coatings may be selected to reduce ghost reflections that could create false spots or bias the centroid of the lateral displacement spot 44. In some embodiments, the lens 26 includes a spectral filter coating or is paired with a separate filter element positioned near the lens 26 or near the camera 28, such that ambient daylight is suppressed while the wavelength of the reflected optical beam 14 is preferentially transmitted to improve spot contrast.

The focal length of the lens 26 may be selected to trade angular sensitivity against packaging length. Longer focal lengths increase the lateral displacement of the lateral displacement spot 44 per unit angular change of the reflected optical beam 14, which can increase measurement resolution for small angular misalignments. Shorter focal lengths reduce the physical length of the optical path between the lens 26 and the image plane 52 and may be selected for compact terminals or integrated receiver-transmitter heads. In some embodiments, the focal length is selected so that the lateral displacement spot 44 traverses a substantial portion of an active sensor area of the camera 28 over an expected alignment error range, while remaining within the sensor area under worst-case perturbations. In other embodiments, the focal length is selected so that spot motion remains within a central region of the camera 28, which may reduce distortion sensitivity and improve centroid estimation accuracy.

In certain embodiments, the lens 26 is positioned such that the image plane 52 coincides with a sensor plane of the camera 28, and the lens 26 is adjusted during assembly to bring the lateral displacement spot 44 into sharp focus at the camera 28. Focus adjustment may be implemented with a threaded lens barrel, shims, spacers, or a kinematic mount. In some embodiments, the lens 26 is fixed after alignment using an adhesive or a mechanical lock to reduce drift. In other embodiments, the lens 26 is mounted on an adjustable stage, such as a fine-pitch translation stage or a flexure stage, to allow periodic recalibration or to accommodate component replacement.

In embodiments, an aperture stop and/or a field stop is associated with the lens 26 to manage stray light and to improve robustness under daylight operation. The aperture stop may be integrated into the lens 26 mount or positioned adjacent to the lens 26 to limit marginal rays that would otherwise increase aberrations or ghosting. The field stop may be positioned at or near an intermediate image plane to restrict the field of view of the camera 28 to a region of interest that contains the lateral displacement spot 44 and, when used, the image of the distant object 34. In outdoor deployments, such stops may be combined with internal baffles, matte-black coatings, and light traps to reduce sun glint, sky background, and off-axis reflections that could reduce measurement fidelity.

In some embodiments, the lens 26 is selected and positioned to support simultaneous measurement of the lateral displacement spot 44 and imaging of the distant object 34. In such embodiments, the lens 26 and the beamsplitter 16 cooperate to direct the reflected optical beam 14 and light from the distant object 34 to the camera 28 with controlled relative magnification and controlled focus at the image plane 52. The lens 26 may be selected to provide a spot size of the lateral displacement spot 44 that supports sub-pixel centroid estimation while remaining large enough to mitigate speckle effects and sensor saturation. In additional embodiments, the lens 26 is selected so that the lateral displacement spot 44 has a controlled intensity distribution, including a near-Gaussian distribution, to support robust centroiding and stable pointing inference by the controller 200.

In further embodiments, the lens 26 is implemented as a reflective focusing element, such as an off-axis parabolic mirror, to reduce chromatic effects and to support broadband operation. Such reflective embodiments may be selected when the system 10 uses multiple wavelengths or when thermal stability and low dispersion are prioritized. The lens 26, whether refractive or reflective, may be positioned and oriented to avoid vignetting of the reflected optical beam 14 and to maintain a predictable mapping between beam angle and spot position at the image plane 52 across the full expected operating range.

The camera 28 is positioned at the image plane 52 and is configured to detect the lateral displacement spot 44 and an image of distant object 34 to determine a direction of the output optical beam 54. The camera 28 observes the lateral displacement spot 44 and the image of distant object 34 at the image plane 52, and the controller 200 interprets a measured spot and image position difference as a pointing observable that corresponds to an angular state of the mirror 18 and, in turn, to a pointing direction of the optical beam 14 exiting the transmit aperture 22. The camera 28 may capture a sequence of frames while the mirror 18 is held at a fixed angular deflection or while the mirror 18 is commanded to step or scan through a set of angular deflections, and the camera 28 may provide spot and distant object 34 image position data to the controller 200 at a rate selected to support closed-loop alignment.

In various embodiments, the camera 28 includes a CMOS sensor or a CCD sensor, and the camera 28 may be selected based on pixel pitch, quantum efficiency, full-well capacity, frame rate, read noise, and dynamic range. For example, a CMOS sensor may be selected for high frame rate operation and low power consumption in fielded optical ground stations, while a CCD sensor may be selected for low fixed-pattern noise and high uniformity when long exposure imaging of the distant object 34 is prioritized. The camera 28 may have a global shutter to reduce rolling artifacts during fast adjustments of the mirror 18, or the camera 28 may have a rolling shutter when scan rates and vibration levels allow accurate centroid extraction.

The camera 28 may include optics and filters selected to pass a wavelength band associated with the reflected optical beam 14 or distant object 34 while rejecting background illumination. In embodiments, a narrowband interference filter is positioned in front of the camera 28 or integrated into a camera window so that ambient daylight and sky background are suppressed while the wavelength of the reflected optical beam 14 or distant object 34 is preferentially transmitted. In other embodiments, the camera 28 includes a long-pass filter, a short-pass filter, or a bandpass filter selected based on the wavelength of the optical beam 14. The camera 28 may further include an adjustable iris or a fixed aperture stop to manage irradiance at the sensor and to reduce stray light. In some embodiments, the camera 28 includes an optical window with anti-reflection coatings and a hydrophobic coating to reduce contamination sensitivity in outdoor deployments.

The camera 28 may implement spot detection and estimation methods that provide stable spot position measurements of the lateral displacement spot 44. In embodiments, the camera 28 and/or the controller 200 performs centroiding of the lateral displacement spot 44 using a center-of-mass method, a matched filter, a Gaussian fit, a correlation method, or a thresholded blob analysis. The centroiding may operate on a region of interest around the lateral displacement spot 44 to reduce computation and improve robustness. In some embodiments, the camera 28 outputs raw frames to the controller 200 for centroid calculation; in other embodiments, the camera 28 includes onboard processing to output spot coordinates and quality metrics, such as spot intensity, saturation flags, signal-to-background ratio, and a confidence score. The camera 28 may further compute a spot shape metric indicative of defocus or aberration, which may be used by the controller 200 to detect optical degradation or misfocus of the lens 26.

In embodiments, the camera 28 is further configured to register an image of the distant object 34 by receiving light incident to the transmit aperture 22, including light from the distant object 34 propagating through the optical system 20, the mirror 18, and the beamsplitter 16 to the lens 26 and the camera 28. This shared-path imaging uses the same optical train associated with transmission through the transmit aperture 22, which supports a practical co-boresighting workflow for deployed optical ground stations where the transmit aperture 22 and the receive aperture 32 are spatially separated yet intended to define substantially parallel optical axes. In such embodiments, the camera 28 provides both a spot-based pointing observable derived from the lateral displacement spot 44 and an object-based reference derived from the image of the distant object 34, and the controller 200 tunes the mirror 18 while the system 10 remains referenced to the same optics that define the transmit pointing direction. In such embodiments, the distant object 34 may be associated with the received optical signal 5 collected at the receive aperture 32, such as a downlink beacon or communication signal, and the camera 28 registers an image of the distant object 34 using light corresponding to that received optical signal 5. The controller 200 then uses the object-based reference to command the mirror 18 so the output optical beam 54 launched through the transmit aperture 22 is directed toward the same distant object 34, thereby supporting co-boresighting between the transmit and receive apertures.

In embodiments, the distant object 34 includes a terrestrial landmark, a building edge, a mountain ridge, a tower beacon, an aircraft, a satellite, or a celestial object such as a star or planet. When the distant object 34 is a celestial object, the long distance provides a reference direction in which parallax between the transmit aperture 22 and the receive aperture 32 is small relative to typical alignment tolerances, supporting high precision co-pointing. When the distant object 34 is a terrestrial landmark or a tower beacon, the distant object 34 may be selected based on visibility, stability, and known location relative to the optical ground station, including a selected distant object 34 that is illuminated or otherwise distinguishable under low-contrast conditions.

The camera 28 may include exposure control, gain control, and dynamic range management to support operation from twilight through daylight. In embodiments, the camera 28 implements automatic exposure control that maintains the lateral displacement spot 44 within an unsaturated intensity range while also maintaining sufficient brightness and contrast for the image of the distant object 34. In other embodiments, the camera 28 operates in a manual exposure mode commanded by the controller 200, including a short exposure mode optimized for the lateral displacement spot 44 and a long exposure mode optimized for registering the image of the distant object 34, with alternating frames or time-multiplexed acquisition. In some embodiments, high dynamic range imaging techniques are used, including multiple exposures combined in software, to allow simultaneous capture of a bright lateral displacement spot 44 and a dim image of the distant object 34. In some embodiments, the camera 28 includes pixel binning or a selectable region-of-interest readout to increase sensitivity or frame rate depending on the alignment mode.

In further embodiments, the camera 28 is mounted in a mechanically stable housing (not shown) that maintains alignment relative to the lens 26 and the image plane 52 under vibration, wind loading, and temperature changes. The camera 28 housing may include heat sinking and thermal control features to maintain stable sensor temperature and stable dark noise characteristics. The camera 28 may also include electromagnetic shielding and filtered power inputs to reduce electrical noise coupling into the sensor readout during actuator operation of the mirror 18.

In certain embodiments, the camera 28 provides additional outputs used by the controller 200 to manage alignment confidence and fallback behaviors. For example, the camera 28 may output a spot validity flag when the lateral displacement spot 44 is not detected, a saturation flag when the lateral displacement spot 44 exceeds a defined intensity threshold, and a background level estimate to indicate daylight glare. The controller 200 may use these outputs to adjust the split ratio at the beamsplitter 16 selection during design, to change the modulation of the laser source 12, to adjust exposure settings of the camera 28, or to switch between spot-based alignment and object-based alignment using the distant object 34.

The controller 200 is configured to adjust an angular deflection of the mirror 18 based on feedback from the camera 28 to align the transmit aperture 22 with the receive aperture 32. In embodiments, the controller 200 operates in a closed-loop mode that iteratively updates a commanded angular state of the mirror 18 using one or more metrics derived from the camera 28, including a centroid position of the lateral displacement spot 44 at the image plane 52, a spot contrast metric, and a validity or confidence metric indicating whether the lateral displacement spot 44 is reliably detected. In embodiments, the controller 200 applies gating logic that ignores frames affected by saturation, transient obscuration, cloud glint, or wind-driven vibration and instead updates the commanded angular state using frames that satisfy predefined quality criteria.

In embodiments, the controller 200 supports multiple alignment modes, including a spot-referenced mode that uses the lateral displacement spot 44 as a pointing observable, an object-referenced mode that uses the image of the distant object 34 as a boresight reference, and a combined mode that uses both the lateral displacement spot 44 and the image of the distant object 34 to improve robustness under changing illumination conditions. In the combined mode, the controller 200 may preferentially weight spot-based feedback when the lateral displacement spot 44 is high contrast and may preferentially weight object-based feedback when background illumination reduces spot contrast or when the distant object 34 provides a stronger reference feature.

In embodiments, the controller 200 tunes the angular deflection of the mirror 18 such that the output optical beam 54 is directed toward the distant object 34 visible to the camera 28, and alignment between the transmit aperture 22 and the receive aperture 32 is achieved by directing at least one of the transmit aperture 22 or the receive aperture 32 toward the distant object 34. The controller 200 may command the mirror 18 according to a step-and-settle approach, a continuous tracking approach, or a scan-and-lock approach, with selection based on expected disturbance bandwidth, link acquisition requirements, and mechanical response of the mirror 18.

In embodiments in which the distant object 34 is a celestial object, the celestial object is located at a distance sufficient such that angular misalignment between the transmit aperture 22 and the receive aperture 32 is negligible, which improves alignment repeatability by reducing sensitivity to local parallax and near-field referencing errors. In such embodiments, the controller 200 may also account for apparent motion of the celestial object due to Earth rotation and may update pointing commands to maintain the distant object 34 within a selected region of interest of the camera 28 over time.

In embodiments, reducing lateral displacement between the transmit aperture 22 and the receive aperture 32 increases alignment precision, and the system 10 is packaged to minimize the physical separation between the transmit aperture 22 and the receive aperture 32 while maintaining thermal isolation, stray-light control, and mechanical clearance. In additional embodiments, the system 10 includes environmental hardening features selected for outdoor optical ground station use, including enclosure sealing to reduce dust and moisture ingress, thermal management to reduce refractive index gradients in the near-aperture air path, and mechanical stiffness features that reduce relative motion between the transmit aperture 22 and the receive aperture 32 under wind loading, handling shocks, or platform vibration.

In some configurations, the transmit aperture 22 and the receive aperture 32 are spatially separated and define respective optical axes that are aligned to be substantially parallel. This geometry may be used when the transmit aperture 22 and the receive aperture 32 are implemented as separate telescopes, separate optical benches, or separate apertures on a shared gimbal, such as to reduce transmitter-to-receiver crosstalk, to support simultaneous transmit and receive without a common aperture, or to accommodate different optical coatings and filter stacks. In such embodiments, the transmit aperture 22 and the receive aperture 32 may have different clear apertures, focal lengths, and fields of view selected for different link budgets and tracking performance, including a narrower field of view associated with the transmit aperture 22 for reduced divergence and a wider field of view associated with the receive aperture 32 for acquisition margin.

In various embodiments, the substantially parallel optical axes are set by a mechanical datum during assembly and are refined during installation using a boresight procedure that references one or more distant objects 34, after which the relationship between the transmit aperture 22 and the receive aperture 32 is maintained as a stored alignment state. The stored alignment state may include a static angular offset between the transmit aperture 22 and the receive aperture 32 and may include one or more correction terms associated with temperature, elevation angle, or gimbal attitude, such as to compensate predictable flexure of a mast, a gimbal frame, or an optical bench. In embodiments, the transmit aperture 22 and the receive aperture 32 are mounted with thermal isolation features that reduce differential expansion while preserving stiffness, including Invar, titanium, carbon-fiber-reinforced polymer, or hybrid structural members selected to manage coefficient-of-thermal-expansion mismatch.

In such embodiments, the controller 200 uses the camera 28 and the lateral displacement spot 44 to maintain the transmit-axis pointing direction while a separate receive pointing mechanism aligns the receive aperture 32 toward the distant object 34, so both optical axes remain parallel over time and across environmental disturbances. In embodiments, the separate receive pointing mechanism includes a gimbal drive, a tip-tilt stage, or a fine-steering element associated with the receive aperture 32, and the receive pointing mechanism uses a separate receive sensor or a received-signal metric associated with the receive aperture 32. In embodiments, the system 10 maintains parallelism by periodically reacquiring the distant object 34 at the camera 28, including reacquisition after wind gusts, slews, or thermal transients that shift a relative orientation between the transmit aperture 22 and the receive aperture 32.

In embodiments corresponding to an on-the-fly alignment calibration architecture of the system 10, the laser source 12 generates the optical beam 14, and the optical beam 14 is launched through the transmit aperture 22 as the output optical beam 54 used as a pointing reference. The beamsplitter 16 divides the optical beam 14 into the first portion 36 directed toward the mirror 18 and the second portion 38 directed toward the retroreflector 24. The mirror 18 steers the first portion 36, and the optical system 20 relays the steered first portion 36 through the transmit aperture 22 to form the output optical beam 54. In such embodiments, the optical system 20 may include one or more relay lenses, relay mirrors, telescope elements, baffles, stops, or edge-blackening features (not shown) that maintain a substantially fixed relationship between an angular command at the mirror 18 and an emitted direction at the transmit aperture 22, and that reduce stray light and ghost reflections at the camera 28. In such embodiments, the first portion 36 may be referred to as a transmit portion that is steered by the mirror 18 and launched through the transmit aperture 22, and the second portion 38 may be referred to as a reference portion that is directed to the retroreflector 24 and returned for formation of the lateral displacement spot 44.

The retroreflector 24 reflects the second portion 38 parallel to the incident beam 40 and returns the reflected optical beam 14 through the beamsplitter 16 to the lens 26, where angular displacement is converted into lateral displacement at the image plane 52 to form the lateral displacement spot 44. In some embodiments, the second portion 38 is selected to be sufficiently low power to avoid saturating the camera 28 while still producing a high-contrast lateral displacement spot 44, and the beamsplitter 16 uses a split ratio selected so the first portion 36 carries a majority of optical power relative to the second portion 38. In some embodiments, the first portion 36 and the second portion 38 share a common optical wavelength and differ by intensity, and in other embodiments the first portion 36 and the second portion 38 are spectrally distinguishable, including use of the optical beam 14 at a wavelength distinct from a communications wavelength while remaining compatible with responsivity of the lens 26 and the camera 28.

The camera 28 positioned at the image plane 52 detects both the lateral displacement associated with the lateral displacement spot 44 and the image of the distant object 34. In some embodiments, the camera 28 processes the lateral displacement spot 44 and the image of the distant object 34 using separate regions of interest on a common sensor array, separate exposure settings applied in time sequence, or optical filtering (not shown) that preserves contrast of the lateral displacement spot 44 while maintaining sufficient scene imaging of the distant object 34. In such embodiments, the image of the distant object 34 is used to define an object-referenced pointing direction and the lateral displacement spot 44 is used to define a self-referenced pointing observable, allowing detection of changes in steering calibration or optical train drift that would otherwise be masked by scene-based tracking alone.

The controller 200 then determines a pointing direction of the output optical beam 54 based on the lateral displacement derived from the lateral displacement spot 44, adjusts the mirror 18 to direct the output optical beam 54 toward the distant object 34, and aligns an optical axis of the transmit aperture 22 with an optical axis of the receive aperture 32 by referencing the distant object 34. In some embodiments, the output optical beam 54 is selected to be eye-safe and may be selected to be spectrally separable from a communications wavelength, and filters at the camera 28 and/or within the optical system 20 (not shown) manage spectral isolation while maintaining sufficient sensitivity under daylight background conditions.

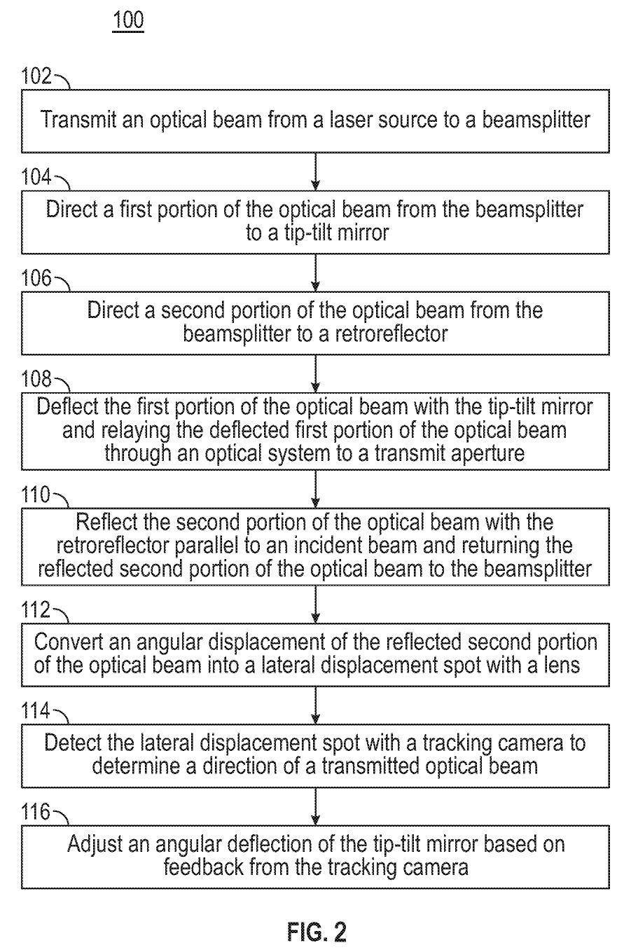

Referring to FIG. 2, a method 100 for aligning the transmit aperture 22 and the receive aperture 32 of an optical ground station is shown. The method 100 uses the optical path and system 10 components described previously as part of system 10, including laser source 12, beamsplitter 16, mirror 18, optical system 20, transmit aperture 22, retroreflector 24, lens 26, and camera 28. In some embodiments, the receive aperture 32 receives the optical signal 5 from the distant object 34, and the camera 28 registers an image of the distant object 34 using light corresponding to the optical signal 5 (e.g., a downlink signal, a beacon, or reflected/ambient light associated with the distant object 34). The method 100 establishes a relationship between angular orientation of output optical beam 54 and the measured lateral displacement spot 44 at image plane 52. This relationship supports determination of pointing direction of output optical beam 54 and supports alignment of respective optical axes of transmit aperture 22 and receive aperture 32. The method 100 may be performed during installation, after environmental disturbance, during scheduled recalibration, or as part of an automated alignment routine controlled by controller 200.

Block 102 includes transmitting optical beam 14 from laser source 12 to beamsplitter 16. Laser source 12 may generate a continuous-wave beam, a modulated beam, or a pulsed beam depending on system configuration and link requirements. In some embodiments, laser source 12 is a semiconductor diode laser operating at telecommunications wavelengths such as 1310 nanometers or 1550 nanometers. In other embodiments, visible or near-visible wavelengths such as 635 nanometers, 780 nanometers, or 850 nanometers are used for alignment visibility during integration and test. Laser source 12 may include temperature stabilization, current control, and power monitoring circuitry to maintain output stability during alignment operations. Optical beam 14 may be single-mode to preserve beam quality and reduce divergence, or multi-mode in lower precision implementations. In some embodiments, the optical beam 14 is produced as a beacon beam used during alignment and may be distinct from a communication beam used during data transmission.

Block 104 includes directing the first portion 36 of optical beam 14 from beamsplitter 16 to mirror 18. Beamsplitter 16 may be implemented as a plate beamsplitter, a cube beamsplitter, or a coated wedge optic. In some embodiments, beamsplitter 16 includes a dielectric multilayer coating selected for a target split ratio and wavelength band. The split ratio may be selected so that a majority of optical power is directed toward mirror 18 to support transmission through transmit aperture 22 while maintaining sufficient optical power in second portion 38 for measurement at camera 28. In some embodiments, beamsplitter 16 is polarization-sensitive, such as a polarizing beamsplitter used with a defined input polarization state, and in other embodiments beamsplitter 16 is polarization-insensitive to reduce sensitivity to polarization drift.

Block 106 includes directing the second portion 38 of optical beam 14 from beamsplitter 16 to retroreflector 24. Retroreflector 24 may take the form of a corner-cube retroreflector, a cat’s-eye retroreflector, or another retroreflective structure configured to return a beam parallel to its incident direction. Retroreflector 24 may be implemented as a prism assembly, a reflective mirror assembly, or a monolithic optic. Materials for retroreflector 24 may include fused silica, BK7, or other optical glass, and reflective surfaces may include protected silver, enhanced aluminum, or dielectric coatings. In some embodiments, retroreflector 24 is configured to laterally translate the beam while maintaining parallelism with incident beam 40, thereby preserving angular information while providing spatial separation that supports downstream conversion by lens 26 and separation within beamsplitter 16. Retroreflector 24 may be mounted using a kinematic mount, a rigid bracket, or a bonded mount to maintain stability over temperature variation and vibration.

Block 108 includes deflecting first portion 36 of optical beam 14 with mirror 18 and relaying the deflected optical beam 14 through optical system 20 to transmit aperture 22. Mirror 18 may be actuated by piezoelectric elements, voice coils, galvanometer motors, or microelectromechanical structures, and may provide angular control in two orthogonal directions. Mirror substrates may include fused silica, Zerodur®, silicon carbide, beryllium, or aluminum depending on thermal stability and mass constraints. Reflective coatings may include protected silver, enhanced aluminum, or dielectric stacks selected for high reflectivity at the wavelength of optical beam 14. Optical system 20 may include one or more lenses and/or mirrors arranged as a relay or telescope. In some embodiments, optical system 20 includes a Galilean telescope for compact packaging or a Keplerian telescope for improved beam shaping and wavefront control. In other embodiments, optical system 20 includes reflective optics such as an off-axis parabolic mirror to reduce chromatic aberration. Optical system 20 may expand the beam diameter, control divergence, and define the transmit optical axis associated with transmit aperture 22. Mechanical mounts for optical system 20 may include athermal spacers, flexure mounts, or kinematic constraints to reduce alignment drift due to thermal expansion.

Block 110 includes reflecting second portion 38 of optical beam 14 with retroreflector 24 parallel to incident beam 40 and returning the reflected optical beam to beamsplitter 16. The incident beam 40 is the beam incident on retroreflector 24 prior to retroreflection. Retroreflector 24 returns the reflected beam substantially parallel to incident beam 40, which supports a repeatable mapping between angular changes of optical beam 14 and the returned beam geometry. In embodiments where retroreflector 24 laterally translates the beam, the returned beam remains parallel to incident beam 40 while being offset spatially relative to the incident path. The returned beam is directed by beamsplitter 16 toward lens 26. In some embodiments, optical coatings and surface quality of retroreflector 24 are selected to reduce wavefront distortion and minimize sensitivity to alignment errors within the retroreflector assembly.

Block 112 includes converting an angular displacement of the reflected optical beam into a lateral displacement spot 44 with lens 26. Lens 26 may be positioned so that angular deviation of the returned beam produces a corresponding lateral displacement at image plane 52. Lens 26 may be a singlet, an achromatic doublet, an aspheric lens, or a multi-element imaging assembly. Materials may include BK7, fused silica, or infrared-transmitting glasses depending on wavelength. Anti-reflection coatings may be applied to reduce losses and ghost reflections. The focal length of lens 26 and the geometry between beamsplitter 16, lens 26, and camera 28 may be selected to set sensitivity, such that a given angular displacement corresponds to a selected lateral displacement magnitude at image plane 52. In some embodiments, lens 26 and camera 28 are positioned on a shared mechanical mount to maintain stable spacing and calibration.

Block 114 includes detecting lateral displacement spot 44 with camera 28 to determine a direction of output optical beam 54. Camera 28 may be a CMOS or CCD image sensor and may include an imaging lens or may directly image at image plane 52 depending on configuration. The camera 28 detects the location of lateral displacement spot 44 in pixel coordinates and the controller 200 converts that location to an angular pointing direction using stored calibration data. In some embodiments, centroiding algorithms are used to determine spot location with sub-pixel resolution, improving angular measurement accuracy. In some embodiments, the camera 28 is configured to detect both lateral displacement spot 44 and an image of the distant object 34 within the same captured frame, which supports alignment routines that reference the distant object 34. Optical filters may be placed in front of camera 28 to suppress background illumination, to isolate the wavelength of optical beam 14, or to balance sensitivity between spot detection and distant-object imaging.

Block 116 includes adjusting an angular deflection of mirror 18 based on feedback from camera 28. Controller 200 receives spot position data from camera 28 and computes a pointing error relative to a desired beam direction. Controller 200 then outputs control signals to mirror 18 to reduce the pointing error. In some embodiments, the adjustment uses closed-loop control with proportional-integral-derivative gains to provide stable convergence and to reject disturbances. In other embodiments, iterative optimization routines are used, including stepwise search, gradient-based adjustment, or adaptive refinement with reduced step size near a target direction. The adjustment may be performed during initial pointing, during periodic recalibration, or continuously during operation to compensate for mechanical drift, wind loading, thermal expansion, or platform motion.

In embodiments, the method 100 further includes registering an image of the distant object 34 by gathering light incident to transmit aperture 22 with camera 28. Light from distant object 34 may propagate through optical system 20, reflect from mirror 18, and pass through beamsplitter 16 to lens 26 and camera 28. The distant object 34 may be a terrestrial landmark, an artificial target, a satellite, or a celestial object such as a star. In some embodiments, the camera 28 operates with exposure control and gain control to accommodate low-light imaging of celestial objects or high dynamic range scenes. In some embodiments, the light gathered from the distant object 34 corresponds to the optical signal 5 received at the receive aperture 32, such as a downlink communication signal, a beacon emitted by the distant object 34, or reflected/ambient light associated with the distant object 34. The camera 28 may register the image of the distant object 34 based on that optical signal 5 while the output optical beam 54 is steered for co-boresighting.

In embodiments, the method 100 further includes directing output optical beam 54 toward distant object 34 visible to camera 28. Controller 200 may compute a relationship between location of distant object 34 in the captured image and the pointing direction derived from lateral displacement spot 44, then command mirror 18 to align the beam direction with the distant object 34. In some embodiments, the method includes verifying alignment by confirming a stable relative position between the distant object 34 and the derived beam pointing direction over multiple frames.

In embodiments, the method 100 further includes directing receive aperture 32 toward distant object 34 to align respective optical axes of transmit aperture 22 and receive aperture 32. Receive aperture 32 may be mounted on a separate gimbal or pointing mechanism and may include a separate sensor for observing the distant object 34. Alignment may be performed by mechanical steering of receive aperture 32, by steering transmit aperture 22, or by steering both such that both optical axes reference the same distant object 34. In some embodiments, the receive aperture 32 includes an acquisition camera or quadrant detector used to point the receive optical axis toward distant object 34.

In embodiments, reflecting second portion 38 of optical beam 14 includes laterally translating optical beam 14 while maintaining parallelism with incident beam 40. The lateral translation may be selected to provide a desired separation between incident and reflected paths for improved optical routing through beamsplitter 16 and to provide a convenient beam geometry at lens 26.

In embodiments, adjusting angular deflection includes tuning mirror 18 in two orthogonal angular directions. Calibration tables stored in controller 200 may map actuator drive signals to angular response. In some embodiments, the mirror 18 includes integrated position sensing and the controller 200 uses the sensor output to improve repeatability and reduce hysteresis effects.

In embodiments, the method 100 further includes recalibrating alignment between transmit aperture 22 and receive aperture 32 in response to environmental or mechanical perturbations. Perturbations may include temperature variation, wind loading, vibration, mounting creep, transportation shock, or structural settling. Recalibration may be performed at scheduled intervals, upon detection of pointing error exceeding a threshold, or upon detection of a change in measured mapping between spot location and commanded mirror position.

In embodiments, distant object 34 is selected such that increasing distance to distant object 34 increases alignment precision. In some embodiments, distant object 34 is a celestial object located at a distance sufficient such that angular misalignment between transmit aperture 22 and receive aperture 32 is negligible for practical alignment purposes.

In embodiments, reducing lateral displacement between transmit aperture 22 and receive aperture 32 increases alignment precision for a given distance to distant object 34. In some embodiments, transmit aperture 22 and receive aperture 32 are mounted to a common optical bench or shared structural frame to reduce relative motion and improve alignment stability.

Various components are described herein to illustrate exemplary architectures for generating, splitting, steering, relaying, and observing an optical beam for alignment between a transmit aperture 22 and a receive aperture 32 in an optical ground station. It is to be understood that such components and arrangements are provided as non-limiting examples. In various embodiments, one or more components may be omitted, combined, rearranged, duplicated, or replaced with other components that are compatible and that provide the same or similar function within the overall system 10.

Accordingly, the disclosed embodiments encompass variations in which the described components are substituted or reconfigured, provided that the system remains operable to form a measurable spot location corresponding to beam pointing direction and provide feedback to controller 200 for adjusting mirror 18 to align the transmit aperture 22 with the receive aperture 32 by referencing the distant object 34.

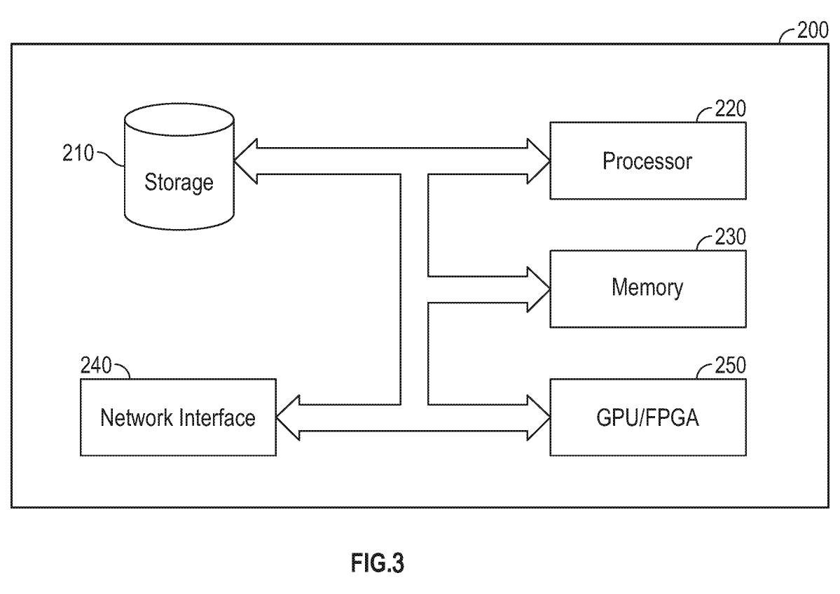

Referring to FIG. 3, the controller 200 is shown. The controller 200 is arranged to coordinate, regulate, and stabilize operation of the system 10 during determination of transmit-beam pointing direction and alignment between the transmit aperture 22 and the receive aperture 32. The controller 200 communicates with and manages the laser source 12, the mirror 18, and the camera 28 to coordinate beam steering, camera acquisition timing, and pointing-direction estimation based on the lateral displacement spot 44 formed at the image plane 52. In operation, the controller 200 uses image data from the camera 28 to tune angular deflection of the mirror 18 to direct the optical beam 14 toward a distant object 34, and to support alignment of optical axes associated with the transmit aperture 22 and the receive aperture 32 by referencing the same distant object 34. The controller 200 includes a storage unit 210, a processor 220, a memory 230, a network interface 240, and a GPU/FPGA 250. These elements operate together to provide deterministic timing of camera sampling, computation of beam direction from the measured location of the lateral displacement spot 44, and generation of control signals for mirror 18 actuation. The controller 200 may operate locally as part of the optical ground station assembly or remotely through a networked supervisory computer, providing automated pointing adjustment, operator visualization, and scheduled recalibration routines.

The storage unit 210 provides nonvolatile data retention for the controller 200 and serves as a repository for operational and calibration data. The storage unit 210 may store firmware images, mirror calibration lookup tables, control gains, alignment routines, and logs of pointing and alignment metrics. In embodiments, stored datasets include time-stamped records of commanded mirror positions, measured lateral displacement spot 44 locations, distant object 34 locations, computed pointing directions, and, when available, environmental data associated with recalibration events. The storage unit 210 may include solid-state drives or flash memory selected for robustness in terrestrial outdoor installations or aerospace environments. The storage unit 210 may support checksum verification and structured storage of alignment histories to support maintenance and fault isolation.

The processor 220 provides centralized computational control for the controller 200. The processor 220 may be a microprocessor, microcontroller, digital signal processor, or central processing unit configured to execute embedded control firmware or a real-time operating system. In operation, the processor 220 orchestrates calibration and alignment sequences, initializes hardware elements, manages closed-loop control of the mirror 18, and executes algorithms to determine pointing direction of the output optical beam 54 based on camera 28 measurements. The processor 220 may compute spot-centroid location for the lateral displacement spot 44, convert pixel displacement into angular displacement using a stored camera and lens calibration model, and generate correction commands that drive the mirror 18 toward a target direction. The processor 220 may also schedule routines for directing the transmit aperture 22 toward a selected distant object 34 and coordinating pointing of the receive aperture 32 toward the same distant object 34 for aperture alignment verification or recalibration.

The memory 230 is operatively connected to the processor 220 and provides storage for runtime data, control parameters, and software routines. The memory 230 may include random-access memory for buffering image frames from the camera 28, storing intermediate spot-detection results, and maintaining recent histories of computed pointing direction and mirror 18 command values. The memory 230 may also store calibration matrices linking pixel location at the image plane 52 to angular displacement, lens parameters used to convert angular displacement into lateral displacement at the camera 28, and reference alignment states for detecting drift over time. In embodiments, the memory 230 stores configurable thresholds and tolerances associated with determining when alignment between the transmit aperture 22 and the receive aperture 32 is within a target range.

The network interface 240 provides wired or wireless connectivity between the controller 200 and external computers or supervisory control systems. Through the network interface 240, operators may monitor pointing direction estimates, view tracking camera imagery of the distant object 34, initiate alignment routines, or retrieve historical alignment data. The network interface 240 may include Ethernet, serial, optical, or radio-frequency links depending on the deployment environment. In remote terrestrial or distributed optical ground station networks, the network interface 240 may support remote health reporting, autonomous alignment scheduling, and coordination between multiple optical ground stations.

The GPU/FPGA 250 is coupled to the processor 220 and provides hardware-accelerated processing for image handling and real-time computation. The GPU/FPGA 250 may execute pipelines that include frame acquisition, filtering, centroid estimation for the lateral displacement spot 44, registration of the distant object 34 within the tracking camera field of view, and fast conversion from measured spot displacement to pointing direction. In embodiments, the GPU/FPGA 250 computes pointing error vectors that are provided to a mirror 18 control loop with low latency, supporting rapid settling and improved stability under vibration or wind loading. The GPU/FPGA 250 may also generate deterministic timing signals to synchronize camera 28 frame capture with mirror 18 actuation updates.

In embodiments, the controller 200 further includes a mirror drive module (not shown) electrically coupled to the mirror 18. The mirror drive module may provide analog or digital control signals that determine angular deflection commands in two orthogonal directions. Closed-loop feedback from integrated mirror position sensors may be used to correct for hysteresis or actuator nonlinearity and improve angular repeatability. In other embodiments, the controller 200 includes a laser control interface (not shown) coupled to the laser source 12 to manage laser operation during alignment procedures, including power management and timing coordination with tracking camera acquisition.

During operation, the processor 220 executes stored control algorithms in the memory 230 to coordinate the system elements. A representative operational sequence includes initializing the laser source 12 and the camera 28, verifying that the camera 28 detects the lateral displacement spot 44 at the image plane 52, commanding the mirror 18 to adjust pointing direction to place the output optical beam 54 on a selected distant object 34 visible in the tracking camera imagery, and recording the corresponding control state as a reference alignment condition. The controller 200 may repeat this process at scheduled intervals or in response to detected changes indicative of misalignment, including temperature variation or mechanical loading, and may provide outputs through the network interface 240 for monitoring or archiving.

Through these coordinated functions, the controller 200 maintains synchronization, pointing stability, and alignment reliability within the system 10. The integration of computation in the processor 220, accelerated image processing in the GPU/FPGA 250, robust data storage in the storage unit 210, responsive working memory in the memory 230, and connectivity through the network interface 240 supports automated alignment verification and recalibration for optical ground stations operating in terrestrial, airborne, or spaceborne environments.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different example embodiments provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for optical ground station transmitting and receiving aperture alignment, comprising:
a laser source configured to generate and transmit an optical beam;
a beamsplitter configured to receive the optical beam from the laser source and to direct a first portion of the optical beam toward a mirror and a second portion of the optical beam toward a retroreflector;
the mirror configured to angularly deflect the first portion of the optical beam;
an optical system configured to relay the first portion of the optical beam from the mirror to a transmit aperture;
the retroreflector configured to reflect the second portion of the optical beam parallel to an incident beam and to return the reflected second portion of the optical beam to the beamsplitter;
a lens positioned to receive the reflected second portion of the optical beam from the beamsplitter and to convert an angular displacement of the optical beam into a lateral displacement spot;
a camera positioned to detect the lateral displacement spot and determine a direction of an output optical beam; and
a controller configured to adjust an angular deflection of the mirror based on feedback from the camera to align a transmit aperture and a receive aperture.

2. The system of claim 1, wherein the retroreflector is configured to translate the optical beam laterally while maintaining the reflected second portion of the optical beam parallel to the incident beam.

3. The system of claim 1, wherein the camera is further configured to register an image of a distant object by receiving light incident to the transmit aperture.

4. The system of claim 3, wherein light from the distant object propagates through the optical system, the mirror, and the beamsplitter to the lens and the camera.

5. The system of claim 1, wherein the mirror is configured to deflect the optical beam within two orthogonal angular directions.

6. The system of claim 3, wherein the controller is configured to tune the angular deflection of the mirror such that the output optical beam is directed toward the distant object visible to the camera.

7. The system of claim 6, wherein alignment between the transmit aperture and the receive aperture is achieved by directing both the transmit aperture and the receive aperture toward the distant object.

8. The system of claim 7, wherein the distant object comprises a celestial object located at a distance sufficient such that angular misalignment between the transmit aperture and the receive aperture is negligible.

9. The system of claim 1, wherein the beamsplitter is configured to transmit a portion of optical power toward the mirror and a portion of optical power toward the retroreflector.

10. The system of claim 1, wherein the transmit aperture and the receive aperture are spatially separated and define respective optical axes that are aligned to be substantially parallel.

11. A method for aligning a transmit aperture and a receive aperture of an optical ground station, comprising:
transmitting an optical beam from a laser source to a beamsplitter;
directing a first portion of the optical beam from the beamsplitter to a mirror;
directing a second portion of the optical beam from the beamsplitter to a retroreflector;
deflecting the first portion of the optical beam with the mirror and relaying the deflected first portion of the optical beam through an optical system to a transmit aperture;
reflecting the second portion of the optical beam with the retroreflector parallel to an incident beam and returning the reflected second portion of the optical beam to the beamsplitter;
converting an angular displacement of the reflected second portion of the optical beam into a lateral displacement spot with a lens;
detecting the lateral displacement spot with a camera to determine a direction of an output optical beam; and
adjusting an angular deflection of the mirror based on feedback from the camera to align the transmit aperture and the receive aperture.

12. The method of claim 11, further comprising registering an image of a distant object by gathering light incident to the transmit aperture using the camera.

13. The method of claim 12, further comprising directing the output optical beam toward the distant object visible to the camera.

14. The method of claim 13, further comprising directing a receive aperture toward the distant object to align respective optical axes of the transmit aperture and the receive aperture.

15. The method of claim 11, wherein reflecting the second portion of the optical beam comprises laterally translating the optical beam while maintaining parallelism with the incident beam.

16. The method of claim 11, wherein adjusting the angular deflection of the mirror comprises tuning the mirror in two orthogonal angular directions.

17. The method of claim 11, further comprising recalibrating alignment between the transmit aperture and the receive aperture in response to environmental or mechanical perturbations.

18. The method of claim 12, wherein the distant object is selected such that increasing distance to the distant object increases alignment precision.

19. The method of claim 11, wherein reducing lateral displacement between the transmit aperture and the receive aperture increases alignment precision.

20. A system for optical ground station transmitting and receiving aperture alignment, comprising:
a laser source configured to generate a beacon optical beam;
a beamsplitter configured to divide the beacon optical beam into a transmit portion and a reference portion;
a tip-tilt mirror configured to steer the transmit portion of the beacon optical beam;
an optical relay system configured to direct the steered transmit portion of the beacon optical beam through a transmit aperture;
a retroreflector prism configured to reflect the reference portion of the beacon optical beam parallel to an incident beam and return the reflected reference portion of the beacon optical beam through the beamsplitter;
a lens configured to convert angular displacement of the reflected reference portion of the beacon optical beam into a lateral displacement at an image plane;
a camera positioned at the image plane and configured to detect both the lateral displacement and an image of a distant object; and
a controller configured to:
determine a pointing direction of the beacon optical beam based on the lateral displacement;
adjust the tip-tilt mirror to direct the beacon optical beam toward the distant object; and
align an optical axis of the transmit aperture and an optical axis of the receive aperture by referencing the distant object.
